(19) United States
(12) Patent Application Publication
(10) Pub. No.: US 2022/0022691 A1
(43) Pub. Date: Jan. 27, 2022

(54) NOVEL GRILL TOP COOKING DEVICE

(71) Applicants: Soam Pralhad Desai, Tracy, CA (US); Roma Pralhad Desai, Tracy, CA (US)

(72) Inventors: Soam Pralhad Desai, Tracy, CA (US); Roma Pralhad Desai, Tracy, CA (US)

(73) Assignees: Soam Pralhad Desai, Tracy, CA (US); Roma Pralhad Desai, Tracy, CA (US)

(21) Appl. No.: 17/076,775

(22) Filed: Oct. 21, 2020

Related U.S. Application Data
(60) Provisional application No. 63/056,599, filed on Jul. 25, 2020.

(51) Int. Cl. A47J 37/07; A23B 4/052

(52) U.S. Cl. CPC A47J 37/0786; A23V 2002/00; A23B 4/052

(57) ABSTRACT

The present invention comprises a novel grill top device generally consisting of a trapezoidal prism-like body and an accompanying lid. The body will be placed on top of a preexisting grill or heat source which allows users to cook with their own grills. The design allows for heat to be trapped and concentrated within the body resulting in high temperatures and even heat distribution. The present invention cooks food in a vertical fashion. The lid is equipped with hooks on the bottom side which are used to hang skewers filled with food items. Skewers are exposed to the same amount of heat from all sides resulting in even cooking. The vertical cooking method prevents cancer causing char marks, ensures sauces or flavorings applied stays onto the food items and does not burn off during the cooking process, and makes flipping of the food items unnecessary.

### FIELD OF INVENTION

The present invention relates to novel cooking and grilling devices used for cooking food. More particularly, the invention relates to a cooking device that is able to cook food items by being placed over top of an existing heat source, namely a grill.

### RELATED ART DESCRIPTION

In the world of grilling, numerous ways exist to cook food over a flame. Unfortunately, each of them has its own downsides. Traditional grills involve a person placing food items over a grill top grate similar to the cooking grill mentioned in U.S. Pat. No. 8,261,732B2. These grills typically have a grate placed over a propane or charcoal heat source along with a lid covering the cooking area.

The first drawback of these traditional grills is fuel economy and unnecessarily long cooking times. These traditional types of grills require preheating which involves heating them without any food items for up to 10-15 minutes. This is done to get the grates inside the grill hot enough so that once the food items are placed on them, the food items cook well. This not only wastes a lot of time, but it also wastes fuel. Also, while cooking with a traditional grill, the user has to repeatedly open the lid to either check upon food being cooked or to flip food items to cook the other side. During this process, heat is lost, and the heat source must again reheat the inside of the grill which results in longer cooking time and/or wastage of fuel. Also, most users prefer a rich, smoky flavor on their grilled food. The need to frequently open the lid of the traditional grill to check upon the food or flip the food results in a loss of the smoke gathered inside the grill every time the lid is opened. This can lead to a loss of flavor in the food items as the smoke has to form again.

Another problem with traditional grills is the need to flip food items during the cooking process. This occurs because the grill is only able to cook one side of the food item at a time. As a result, the user needs to constantly monitor the food being grilled and flip the food items at an appropriate time. Another drawback of traditional grills is that cooking using a traditional grill frequently leads to uneven cooking. This especially applies to food items that are uneven in shape since the entire food item may not make contact with the grill and some of it may remain undercooked or uncooked.

Traditional grills also suffer from flare ups where the food can end up being badly burned. In addition, since only one side of the food item gets cooked at a time, one side of the item can cook more than the other side if they are not cooked for the same time or if one side cooks faster than the other. In the case of a traditional grill, users will have to keep track of which items are flipped and which ones are not. This can lead to errors on the user's side which can lead some food items being undercooked or overcooked. Another problem with having to flip food items over and over again is the loss of flavor. The spices or seasoning on the food items can fall off and/or stick to the grilling surface resulting in a loss of flavor. Additionally, another problem with traditional grills is the fact that when food is placed on the grates, the food tends to stick to the grates and becomes difficult to remove. This results in loss of the caramelized ‘skin’ of the food which contains most of the flavor that users desire.

Another problem with traditional grills arises from the fact that the grates of a traditional grill are difficult to clean. Because of this, food that is grilled for vegetarians or vegans often needs to be cooked on the same grates as those who eat meat. This is undesirable for vegetarians or vegans since most do not approve of their food being contaminated by meat residues. Complete meat residue or other food residue removal by cleaning the grates (especially while they are hot) is difficult. Users are also required to clean the grills frequently to remove food items stuck to the grates to maintain the heat efficiency of the grates and avoid flare ups. This again can take up a lot of time and resources.

In addition to the difficult cleaning process of traditional grills, when food is cooked in a traditional grill, the grates leave char marks on the food. These chars marks contain cancer-causing chemicals called heterocyclic amines (HCAs), as per Dr. Stephen Freedland, director of the Center for Integrated Research in Cancer and Lifestyle (CIRCL). Also, when fat from the food drips into the grill, the resulting flames can cover food with polyaromatic hydrocarbons (PAHs), another chemical linked to cancer.

Another issue with traditional grills is their inability to cook large sized food items well, such as whole chicken for example. Due to the proximity of the food to the heat source and the uneven heating profile of a traditional grill, large food items will typically burn from the outside before being fully cooked inside.

There are some solutions that try to fix these problems, but they do so with limited success. One of these solutions comes in the form of gridirons or raised surfaces that are placed on a grill. An example of this is seen in U.S. Pat. No. 261,870A. Solutions like these are able to prevent the effects of flare ups from affecting the cooking of the food items, but they still suffer from the other problems mentioned above.

They are usually not covered by the grill lid which makes it difficult for these devices to trap heat effectively. Heat from the heat source will immediately escape to the surrounding area which will make cooking less efficient. Also, the problem of flipping the food items still remains with the gridiron design. The user will still have to turn the food over to cook both sides of the food item which can lead to uneven cooking.

In addition, the problem of food sticking to the cooking surface and the need to clean the cooking surface frequently continues to exist in the case of gridirons. Also, similar to the traditional grills, the gridiron design will still require that the cooking surface be cleaned before switching from meat cooking to vegetarian cooking to avoid the meat contamination problem for vegetarians and vegans.

As described above, traditional grills and gridiron-like designs are not ideal. They both have their own shortcomings. Grills in a vertical form attempt to fix some of these problems. These are typically hollow drums with vertical walls and an opening at the top with the ability for the user to suspend food in air above the heat source. An example of such a vertical grilling device can be seen in U.S. patent US20130014743A1. It describes a portable barrel cooker that is capable of cooking food items over a charcoal heat source which is located at the bottom of the barrel. Food is attached to hooks that are then suspended on suspension members which look like rods that run across the entire diameter of the barrel. These types of grills have some advantages over the devices mentioned above.

Because the food items are suspended at a distance from the heat source, they are not affected by flare ups from the heat source. This may lead to more consistent cooking of the food items since the food does not burn due to flare ups. Also, when the food items are suspended, they do not need to be turned over or flipped during the cooking process. The heat source is only at the bottom so both sides of the food items are being cooked at the same time. Another benefit of vertical cooking is that since the food items are not touching the grill grate, the food items do not lose any of the applied flavorings/sauces which make the cooked food items more flavorful. Also, since the food items are suspended and are not in contact with the grill grates, the food items will not develop any cancer-causing char marks.

Even with the above advantages, there are many disadvantages associated with the above vertical cooker. One of the first drawbacks of the above vertical cooker is the inability for users to use their existing grills or heat sources. The vertical cooker comes with its own heat source basket which needs to be filled with a pre-measured amount of charcoal or wood. It cannot take advantage of existing heat sources the user may already own. For example, if the user wishes to use his or her own gas grill, in which he/she has already invested, using such an external heat source is not supported. Buying the vertical cooker separately in addition to an already existing traditional grill, which most users have, only to cook food in a suspended fashion may not make sense to most users. Vertical cookers can often cost as much or even more than a traditional grill, making them expensive to buy, and difficult to store and use for most users.

Another downside of the above vertical cooker is that it does not support grilling with propane gas. It requires the use of fuels such as charcoal or wood instead of propane gas. A significant disadvantage of charcoal or wood over propane gas is that they take more time to ignite, leave ash behind, are more expensive to buy, heavier to carry, take more space to store and are more difficult to use/light. Many users prefer the speed, convenience and cleanliness of propane as a fuel. It does not support propane gas as a heat source which is a big showstopper for many users.

In addition, the vertical cooker is time consuming to use. Food items in it are mounted on S′ hooks which are then hung on to the suspension members. Use of ‘S’ hooks means each piece of food must be carefully mounted on before cooking and removed off of the ‘S’ hook after cooking which is time consuming and inconvenient for many users. There is also the possibility that the hook may cut through softer food items or heavy food items hung at the very edge resulting in the food item falling into the heat source. Additionally, there is the possibility that the user could lose the small ‘S’ hooks after a few uses and may end up in having to buy more to replace the lost hooks. Since each piece of food requires its own hook, many hooks will be needed for a user to be able to cook a reasonable amount of food. This can quickly become quite expensive and can become a significant inconvenience for many users.

A need exists for a low cost, portable device that can be placed on top of an existing grill or a heat source. A need also exists for a device that can cook food evenly irrespective of the location of the food inside the device's body and infuse a smoky flavor in the food items. Additionally, a need also exists for a device that will allow the vertical suspension of food items above a grill heat source. Finally, a need also exists for a device where food can be hung on skewers vertically without different food items touching each other, a device where it is safe and easy to add or remove food while the cooking is in progress, and a device where food items will not contact or stick to a grill's grates so that frequently cleaning the cooking grates becomes unnecessary. Such a device also needs to allow users to vertically cook large amounts of food in a relatively small volume, allow users to cook large pieces of food reliably without undercooking or overcooking and allow the users to enjoy all the benefits and convenience of vertical grilling.

### BRIEF SUMMARY

The present invention comprises a novel grill top device generally consisting of a trapezoidal prism-like body and an accompanying lid. The body will be placed on top of a preexisting grill or heat source which allows users to cook with their own favorite grills. The lid is equipped with hooks on the bottom side which are used to hang skewers filled with food items. The heat source of the preexisting grill will be used to heat the food items inside the body without requiring said preexisting grill to be preheated.

The design fits on two average sized gas grill burners and allows for heat to be trapped and concentrated within the body resulting in even heating of the food items. The lid prevents heat from escaping the body. All the heat from the heat source is trapped and is used to cook the food items which causes the inside of the body to reach much higher temperatures than what is possible with just a heat source. Since the food is cooked evenly at much higher temperatures, it cooks faster, retains most of its juices, doesn't dry out and uses relatively less fuel. In addition to the heat, the body also traps smoke to infuse food items with a rich, smoky flavor. The body is assembled by screwing together four separate pieces which allows for easy transportation and storage.

The hooks allow skewers to hang vertically resulting in a high cooking capacity within a small space and also allows both sides of the skewers to be exposed to the same amount of heat. This means all types of food items, large such as whole chickens or small such as kabobs, will be cooked evenly. This vertical cooking prevents cancer causing char marks, prevents potential flame flare ups from the heat source that may burn the food, and makes flipping of the food items unnecessary. The vertical grilling also ensures sauces or flavorings applied stay onto the food items and do not burn off during the cooking process.

The lid possesses a handle to easily pick up the lid to either attach skewers, remove skewers once the food items are done cooking, or check upon the progress of food items while they're cooking. Similarly, the body possesses two side handles to easily transport the entire device. In addition, the lid edges are bent to ensure the lid will be easy for the user to position on the body correctly and will not fall off due to slight movement. Finally, the present invention ensures food items (for example meat and vegetables or food with different flavors) will not touch each other and contaminate. All the skewers hang apart from one another and do not touch the heat source or grill grates. This prevents the need for having to clean the hot grill grates during different cooking cycles since the food items never come in contact with the heat source or grill grates and therefore do not stick to the grill grates.

### DRAWINGS BRIEF DESCRIPTION

The figures included serve as examples of some embodiments of the present invention. The present invention is not limited by the figures depicted in the drawings.

FIG. 1 depicts an example of the present invention in its assembled state according to various embodiments of the present invention.

FIG. 2 depicts an example of an exploded view of the present invention according to various embodiments of the present invention.

FIG. 3 depicts an example of a front view of the present invention according to various embodiments of the present invention.

FIG. 4 depicts an example of a side angled view of the present invention with the hooks visible according to various embodiments of the present invention.

FIG. 5 depicts an example of an exploded view of the present invention's top handle according to various embodiments of the present invention.

FIG. 6 depicts an example of an exploded view of the present invention's side handle according to various embodiments of the present invention.

FIG. 7 depicts an example of the present invention's lid being placed in the ‘skewer mounting’ position according to various embodiments of the present invention.

FIG. 8 depicts an example of a bottom view of the present invention's lid being placed in the ‘skewer mounting’ position according to various embodiments of the present invention.

FIG. 9 depicts an example of a close-up view of the present invention's lid according to various embodiments of the present invention.

### DETAILED DESCRIPTION

The terminology used herein is for the purpose of describing different embodiments only and is not intended to limit the invention. The words “and/or” include all combinations of one or more of the associated listed items. As used herein, the singular forms “a,” “an,” and “the” are meant to incorporate the plural forms and the singular forms, unless stated otherwise. Also, the words “comprises” and/or “comprising,” specify the presence of the stated elements, but do not exclude other elements not stated. Unless otherwise defined, all terms used herein have the same meaning as usually understood by one having ordinary skill in the art to which this invention belongs.

In describing the invention, the steps and techniques are disclosed. Each of these steps and techniques have individual benefits but can also be used with one or more, or in some cases all, of the other steps and techniques acknowledged. For the sake of clarity, this description will not repeat every possible combination of the individual steps unnecessarily. However, it must be understood that such combinations are entirely within the scope of the invention and the claims. New grill top cooking devices are discussed herein. For the purpose of explanation, in the following description multiple details are expressed in order to provide an accurate perception of the present invention. It will be clear, however, to one skilled in the art that the present invention may be used without these specific details. The present disclosure is to be considered as an example of the invention and is not intended to limit the invention to the specific embodiments described below. The present invention will now be discussed and explained further by referencing the attached images below. For the sake of brevity, the present invention may be referred to as “the device” in some places throughout the rest of the description.

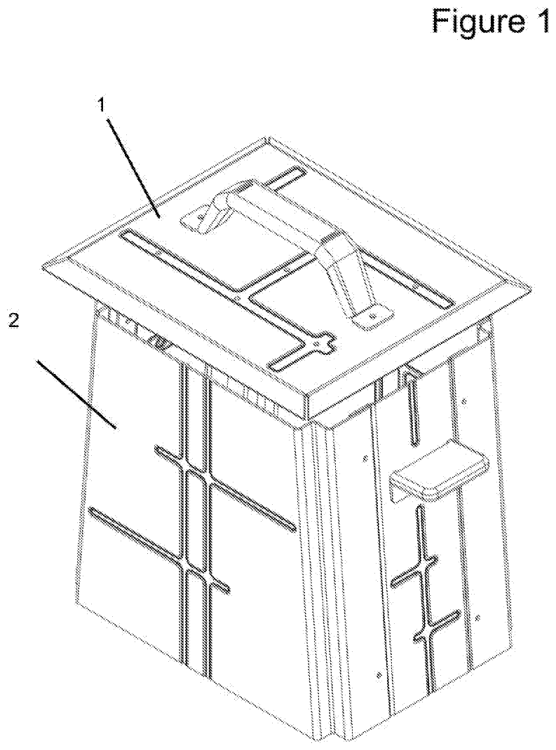

FIG. 1 shows a diagram of the device. It is used to cook food items in grilling settings. The device will sit on top of an existing grill or heat source. The heat source of the preexisting grill will be used to heat the food items inside the body 2. Food items will be placed on skewers and then hung vertically inside the device. In this way, the device makes use of an existing heat source to cook food items.

The present invention comprises a box-like body 2 along with a lid 1. In the preferred embodiment, the body 2 is in the shape of two parallel trapezoids connected together forming a trapezoidal prism shape however alternative embodiments could include but are not limited to cubes, rectangular prisms, triangular prisms, cylinders or other 3D prism-like objects. In the preferred embodiment, the lid 1 is of a rectangular shape with side flanges at a 30-degree angle. Alternative embodiments could include squarish, rectangular or any other shape for the lid 1 and body 2. The preferred embodiments of both said body 2 and said lid 1 is made out of 2.5 mm thick aluminum but can also be made of, but not limited to: carbon steel, stainless steel or other suitable metals or materials. Alternative embodiments may also include varying thickness of the material. The preferred embodiments of both said body 2 and said lid is cut out of sheet metal however other processes can be used to acquire the desired shape such as, but not limited to: die casting, milling, or any other metal or material fabrication method. Being made out of aluminum allows the device to keep its strength and form after repeated heating and cooling cycles. The device material thickness of 2.5 mm makes it so that the device will not bend, twist, or deform during use but will still provide adequate strength and support.

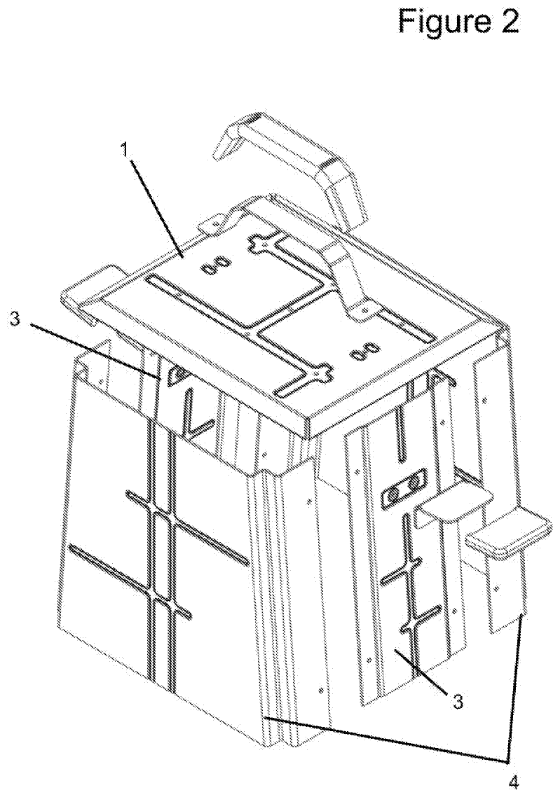

FIG. 2 shows an exploded view of the body 2. In the preferred embodiment, the body 2 is made up of four different pieces screwed together to form a trapezoidal prism-like apparatus. The front and back pieces 4 are approximately 350 mm by 330 mm in the preferred embodiment. The left and right side pieces 3 are approximately 150 mm by 330 mm in the preferred embodiment. The lid 1 is approximately 300 mm by 250 mm with 20 mm long flanges along the sides in the preferred embodiment. These measurements are only for the preferred embodiment of the present invention and alternative embodiments may include other dimensions for the front/back pieces 4, side pieces 3, and lid 1 size.

FIG. 1 illustrates the body 2 of the present invention. The top is to be covered by the lid 1 and the bottom is left open. The device is designed so that users may use the device on top of their existing heat source, namely a grill. It allows users to extend functionality of their current grill or heat source without having to spend large amounts of money on a different type of grill altogether. In addition, it allows users to choose their own heat source. Users may use the device with gas, charcoal, or any other heat source.

The body 2 shape allows for better heat trapping and concentrates the heat around the food items. When the lid is put on, the body 2 encloses all the food items and the heat is unable to escape from the top. As a result, all the air inside the device reaches the same temperature and maintains a constant amount of heat inside the device. This results in all the food items receiving even heat and as a result prevents undercooking or overcooking of the food items. Since all the food items receive the same amount of heat at the same time, there is no risk of one side burning while the other side is still uncooked. In addition, heat coming off of the heat source is trapped inside the body of the device. This causes the inside of the body to reach much higher temperatures than what is achievable with a heat source on its own. Since the food is cooked evenly and at much higher temperatures, it cooks faster, retains most of its juices, and doesn't dry out. All the heat produced goes towards cooking the food items and as a result, saves both time and fuel for the user.

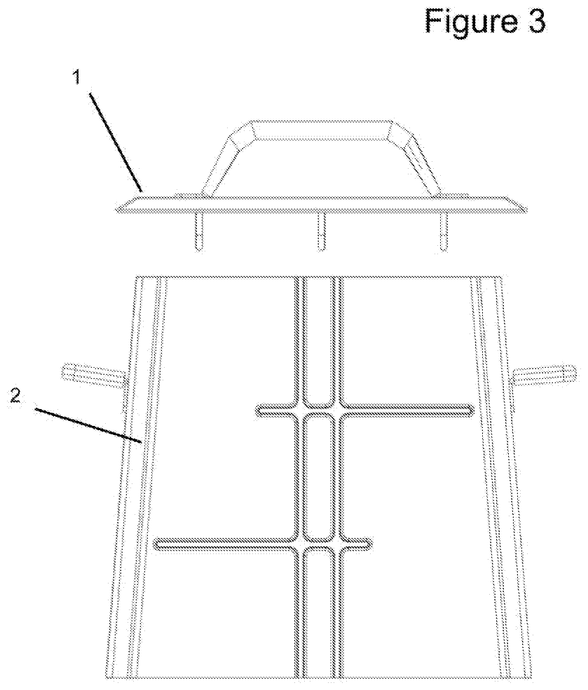

FIG. 3 shows a front view of the body 2. In addition, the body 2 shape directs heat from the bottom to the top. Because of the trapezoidal front structure in the preferred embodiment, the bottom is wide enough to gather heat and deliver it to the top. While the preferred embodiment shows a trapezoidal structure, alternative embodiments may include squarish, circular, triangular or other shapes as well. Alternative embodiments may also include different dimensions for the size of the front piece. Also, since the heat source is at the bottom of the device, the bottom pieces of food may experience more heat than the food pieces at the top; however, since hot air is lighter than cool air, the hot air stays at the top of the device while the heavier air cooled from cooking the food escapes out of the bottom of the body 2. New hot air is then again supplied by the heat source. This creates a continuous, even flow of hot air around food, ensures that the temperature inside the device stays near constant, ensures the food items retain most of their juices and ensures the food items are cooked quickly and evenly.

In addition, the body 2 shape traps the smoke coming out of the burning charcoal or the smoke generated by the burning of the drippings from the food falling on the charcoal and grates and stores it within the body 2. The smoke created during the cooking process does not simply vanish into the air without imparting smoky flavor to the food. This process infuses the food items with a rich and smoky flavor. The body 2 prevents the smoke from escaping and as a result, it takes much less time to give the food items a smoky flavor that would have been difficult to achieve otherwise. The trapping of the smoke ensures that the food items are infused with a smoky taste by the time they are finished cooking. The ability of the device to trap smoke allows the user to cook better tasting food by maximizing the use of the smoke generated during the cooking process.

In addition, the device is designed to fit over two burners in most multi-burner grills. In the preferred embodiment, the body 2 (when assembled) is about 350 mm in length and 250 mm in width but alternative embodiments may include other dimensions for the body 2 assembled length and width to include more or less burners. This design ensures that when the device is used, all the heat generated from the heat source will be funneled into the body 2 and in turn to the food items. This prevents the wastage of heat and results in more time efficient cooking.

FIG. 2 shows an exploded view of the body 2. The body 2 was designed to comprise four pieces that are screwed together to form a box-like apparatus. This four-piece design was designed to allow for easy transportation of the device and to allow easy storage for the user. On the side pieces 3, the two side flanges with screw holes are pushed in at a distance of 2.5 mm and are about 20 mm in width. This is designed so the side pieces 3 can easily fit into the 2.5 mm thick front and back pieces 4 without leaving any metal sticking out in the preferred embodiment. This is done so the pieces can be easily connected and the sides of the device remain perfectly smooth to prevent finger cuts or other injuries when handling. This is in the preferred embodiment however alternative embodiments may include different dimensions for the side piece 3 flanges.

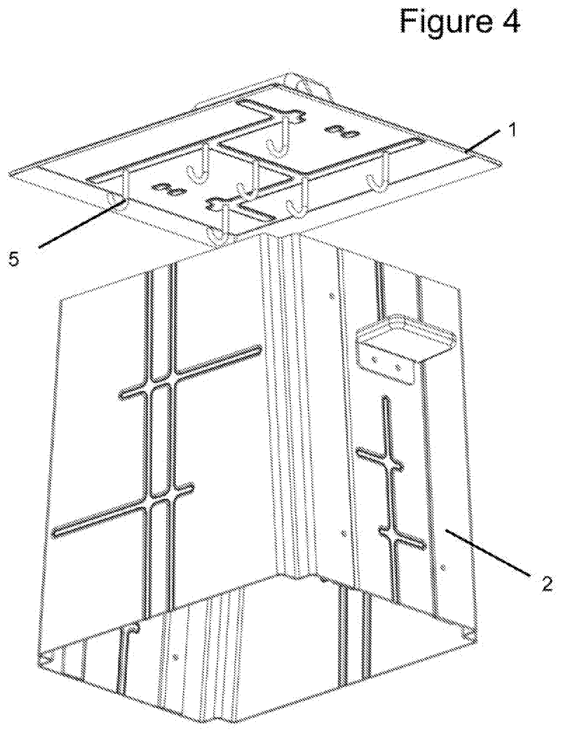

FIG. 4 shows the hooks 5 of the device. In the preferred embodiment, there are seven hooks 5 attached to the lid 1 but alternative embodiments may include any number of hooks 5. In the preferred embodiment, the hooks 5 are spaced evenly about 60 mm apart with one hook 5 in the center but alternative embodiments may include different spacings and configurations. While the preferred embodiment of the present invention involves a configuration for vertically hanging skewers, alternative embodiments may include other methods of skewer placement such as but not limited to horizontally placed skewers, skewers placed at an angle, or any other configuration of skewers.

This process of suspending the skewers in the air or, vertical grilling, allows for all sides of the food to be covered by heat evenly to an even greater extent. Since the body 2 encloses heat evenly as mentioned above, vertical grilling further allows the user to cook large quantities in a small space. A large amount of food can be cooked in the same space since vertical grilling ensures all sides of the food receive the same amount of heat. It prevents one side being cooked more or less than the other side since the heat surrounds all the hanging skewers equally.

In addition, the device allows for a much wider range of objects that may be cooked. Aside from small meat pieces, other food items such as bread, whole chickens and many other items can also be cooked. The even heating aspect enables objects to be cooked without the danger or one side cooking faster than another—a trait that is necessary in cooking large food items such as whole chickens or bread.

In addition to even heat distribution, the vertical grilling prevents char marks on the food items. Char marks on meat or other food items produce a compound known as heterocyclic amines (HCAs), HCA's have been linked to increase the risk of cancer. By using vertical grilling, the device cooks food items that achieve the same or better flavor without the associated health risks.

Another benefit of vertical cooking is that sauces, flavorings, and other substances stay on the food items while cooking. Vertical grilling makes sure food items are not in direct or close contact with the flames or grates which may burn off any sauces or flavoring applied to the food items before cooking. In the vertical setting, the heat surrounds the food items and the sauces or flavorings solidify on the food items making them retain their flavor. This results in more flavor, better quality food, and less wastage of sauces or flavorings.

Finally, vertical grilling prevents the need for constantly monitoring the food items. With vertical grilling, the food items are surrounded by a uniform heat profile so there is no need to move skewers around during the cooking process. The user can simply check on the skewers from time to time and does not need to risk handling hot items for flipping or otherwise moving around. This serves to make the cooking process much simpler, safer and less time intensive for the user.

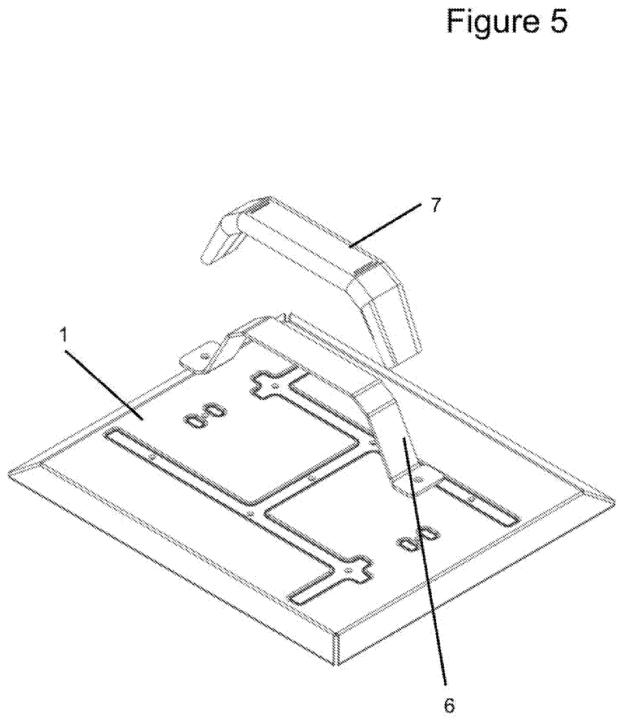

FIG. 5 shows an exploded view of the top handle frame 6 and the silicone top handle sleeve 7 on the lid 1 of the device. In the preferred embodiment, the top handle frame 6 is about 240 mm in length with the top flat section being 128 mm but alternative embodiments could include other dimensions. In the preferred embodiment, the top of the top handle frame 6 sits 50 mm up from the lid 1 but alternative embodiments could include other height dimensions. This is designed so that users do not accidentally touch the hot, metal lid 1 when they grab the handle to lift the lid 1. In the preferred embodiment, the top handle frame 6 has an approximately 1 inch by 1-inch area of contact on both sides of the top handle frame 6 with the lid 1 but alternative embodiments could include different areas for this contact point. This area is used to screw the top handle frame 6 on to the lid 1. This area is kept small so that the lid 1 transfers minimal heat to the top handle frame 6. In the preferred embodiment, the top handle frame 6 is shaped as an arc but alternative embodiments could include rectangular, circular, or other shapes used to create a handle.

Like the body 2 of the device, the top handle frame 6 is made out of 2.5 mm thick aluminum but can also be made of, but not limited to: carbon steel, stainless steel or other suitable metals or materials. In the preferred embodiment, the top handle frame 6 is fitted with a silicone top handle sleeve 7 however, alternative embodiments could include other materials such as but not limited to nylon, bakelite, other high heat plastics or other heat resistant materials. In the preferred embodiment, the silicon top handle sleeve 7 can be slid onto the metal handle frame 6 but alternative embodiments could include silicone dipping, snapping, or different methods of attaching the top handle sleeve 7 to the top handle frame 6. In the preferred embodiment, the silicone top handle sleeve 7 is of a long tubular shape but alternative embodiments could include rectangular prism like, triangular prism like, shape of the top handle frame 6 or any other shape representing a handle. This is designed so that users may lift the lid 1 without burning themselves to check on the cooking process of the food items while the rest of the device is still hot.

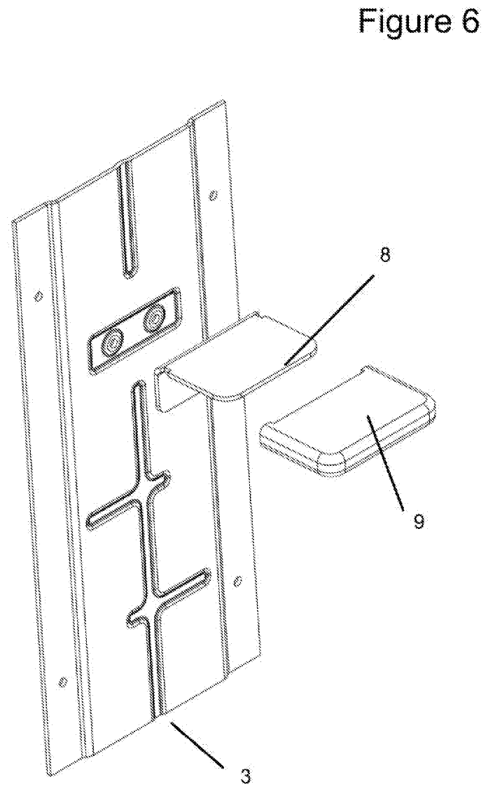

FIG. 6 shows an exploded view of the side handle frame 8 and side handle sleeve 9 of the device. In the preferred embodiment, the side handle frames 8 are about 50 mm by 70 mm. In the preferred embodiment, the side handle frames 8 have a 70 mm by 30 mm panel coming down with two holes for screws. The panel is used to attach the side handle frame 8 to the side pieces 3 of the device. These are all dimensions for the preferred embodiment, but alternative embodiments may include other dimensions for the side handle frame 8 length, width, and panel size. In the preferred embodiment, the side handle is shaped as a rounded rectangle, but alternative embodiments could include rectangles, ovals, hollow rectangles or other shapes used to create a handle.

Like the body 2 of the device, the side handle frame 8 is made out of 2.5 mm thick aluminum but can also be made of, but not limited to: carbon steel, stainless steel or other suitable metals or materials. In the preferred embodiment, the side handle frame 8 is fitted with a silicone side handle sleeve 9 however alternative embodiments could include other materials such as but not limited to nylon, bakelite, other high heat plastics or other heat resistant materials. The silicon side handle sleeve 9 can be slid onto the metal side handle frame 8 but alternative embodiments could include silicone dipping, snapping, or different methods of attaching the side handle sleeve 9 to the side handle frame 8. In the preferred embodiment, the silicone side handle sleeve 9 is of a rounded rectangular shape but alternative embodiments could include rectangles, ovals, hollow rectangles or other shapes used to create a handle. This is designed so that users may lift the entire device without burning themselves to move the device while the object may still be hot.

In addition to the handles, the device removes the need for preheating before beginning the cooking process. As shown in FIG. 1, the lid 1 on top of the body 2 encloses all the heat inside. Since all the heat generated by the heat source is instantly collected and contained, the startup time for cooking is very short. There is no need to wait until a certain temperature is reached. This containment of heat also causes the inside of the body to reach much higher temperatures than what is achievable with a heat source on its own as mentioned previously.

FIG. 4 shows how the lid 1 can be lifted to check on the food contents during the cooking process. In the preferred embodiment, the device is only opened from the top. However, in alternative embodiments, the openings can be in other locations such as but not limited to the front, back, or sides. This top opening is designed to make sure minimal heat is released when checking on the food items and so that users have a full view of their food items when checking on said food items. Opening from the top allows users to fully lift the food items into view. Users can quickly look at all of the food items at once. This is also beneficial for quickly removing or transporting all skewers at one time. This ensures that the state of the food items is accurately assessed during the cooking process. This makes sure that the food items are never uncooked or overcooked due to a lack of visibility. This also ensures that minimal heat is lost during the cooking process which saves fuel and time needed to finish cooking the items.

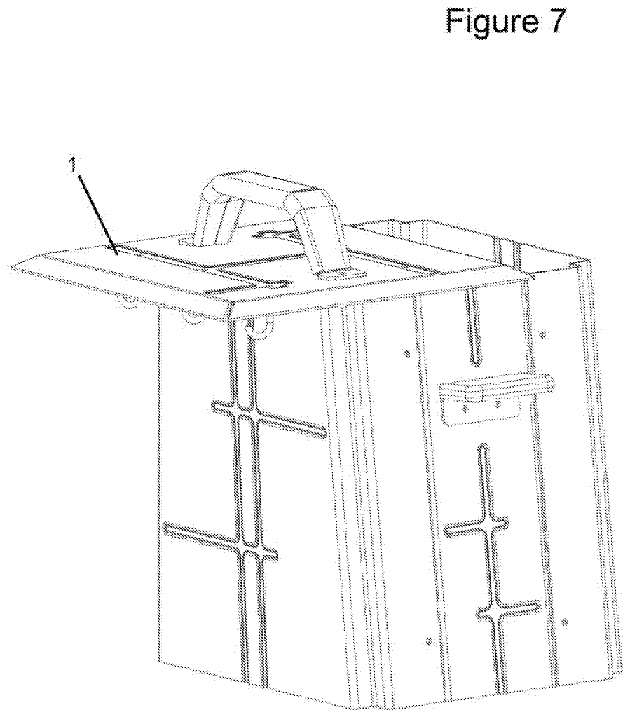

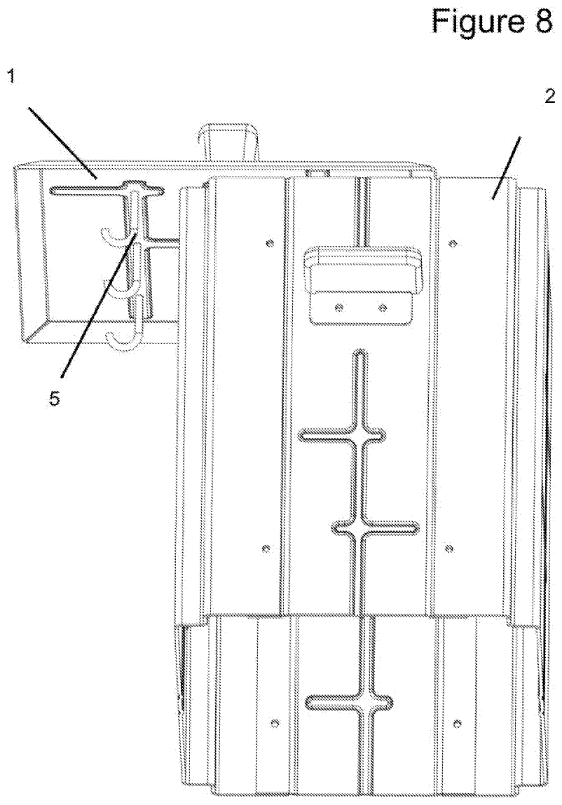

In addition, the width of the body 2 and spacing between the hooks on the lid 1 make the initial hanging of the skewers easy. FIG. 7 shows how the lid 1 may be placed in a skewer mounting position when inserting or removing skewers. As shown FIG. 8, out of the seven hooks 5, three of them are outside of the body 2. Once the user puts a skewer on the middle hook 5, they may move the lid 1 into this skewer mounting position as shown in FIG. 7. When the lid 1 is placed in this manner, the user may easily hang skewers on three hooks 5 on the sides as shown in FIG. 8. Then, the user may move the lid 1 to the other side to hang the other three skewers on the remaining three hooks 5. This allows the user to insert or remove skewers without having to hold the weight of all seven skewers at the same time.

In addition, the hooks 5 attached to the lid 1 makes inserting new skewers or removing cooked skewers from the device an easy and effortless process. Users can lift the lid 1, move away from the grill or any heat source, insert or remove their skewers in a harm-free zone, and then simply place the lid 1 back onto the body 2 of the device. This allows users to easily transport all seven skewers at the same time if they choose to. This ensures user safety and reduces stress on the user's side.

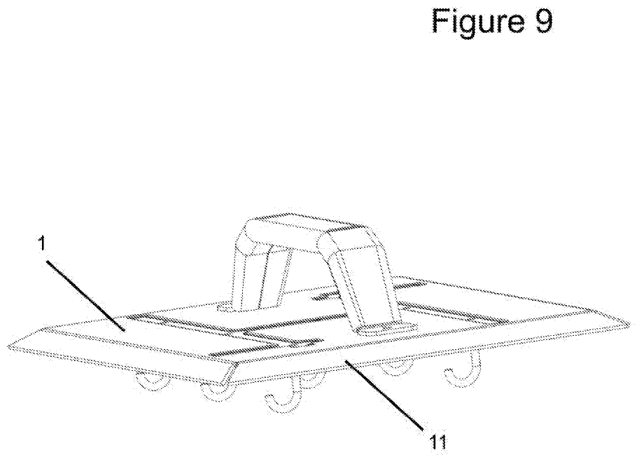

In addition to the easy skewer inserting/removing, the lid is designed to ensure it will not easily fall off of the device. As shown in FIG. 9, the lid edges 11 are bent at a 30-degree angle and come out 20 mm in the preferred embodiment however alternative embodiments may include other angle sizes and lid edge 11 lengths. This is designed so that the lid 1 can easily be placed on the device but still does not fall off the device. Since the lid edges 11 come out at an angle, the lid 1 guides the user to place it and fit it correctly in the right place. The bottom of the device fits exactly within the flat portion of the lid 1. The angled lid edges 11 make sure the lid 1 will not fall if rocked slightly.

In addition, the device allows for no contamination of food items since there is no contact of food with the grill or heat source. This is especially beneficial when the same heat source is being used to cook food items for vegan or vegetarian people as well as meat eaters. Often, vegans or vegetarians do not want their food items in contact with meat or meat byproducts. Also, many times, users do not want food with different flavorings to mix with each other. This device ensures that food items of different categories do not come into contact with one another. As shown in FIG. 4, the spacing of the hooks 5 ensures that the food mounted on individual skewers will not touch each other during the cooking process when the recommended amount/size of food is mounted on the skewers. When food on a particular skewer is cooked, it can be taken out of the device by simply raising the lid 1, removing the cooked skewer, and another clean skewer with another food item can be mounted. Since the food items never touch the heat source or grill grates, there is no need for the user to clean hot objects with burnt food on them.

Instead of having to clean the hot grill grates, users can simply attach a new skewer with desired food item mounted on it inside the device. This allows the same heat source to be used without risking contamination or having to clean hot objects in between cooking cycles. The device also ensures that food items do not stick to the grilling surface during the cooking process. Since the skewers are hanging apart from each other, suspended in the air and not touching the grilling surface, they can be easily removed and the next set of skewers can be put on without the need for cleaning the grates or having to remove leftover food from the grates in between cooking cycles.

We claim:

1. An apparatus that comprises a rectangular body with two handles with silicon coverings on the shorter side of said body along with a rectangular lid that sits on top of said body where said lid contains hooks on its underside and a handle with a silicon covering on its topside.

2. The apparatus of claim 1 wherein said apparatus sits on an existing grill or heat source and utilizes existing heat sources to cook food items.

3. The apparatus of claim 1 wherein said apparatus does not require preheating of said grill to begin cooking items resulting in time saving and fuel efficiency.

4. The apparatus of claim 1 wherein said body is shaped so that it is able to concentrate heat and cook food items evenly regardless of their location inside said body.

5. The apparatus of claim 1 wherein said body is shaped so that it is able to concentrate smoke and infuse all food items with a rich, smoky flavor.

6. The apparatus of claim 1 wherein said body's dimensions at its base allow it to fit over 2 standard sized gas grill burners.

7. The apparatus of claim 1 wherein said body contains 2 handles with silicone coverings on the sides of said body which allow said apparatus to be picked up and moved even when said apparatus is hot.

8. The apparatus of claim 1 wherein said lid comprises a rectangular plate with angled sides, fitted with a silicone covered handle on its top side and hooks on its underside that are used to mount skewers filled with said food items.

9. The apparatus of claim 1 wherein said lid sits on top of said body to allow the inside of said apparatus to trap heat and reach a higher cooking temperature than possible with just a heat source resulting in food being cooked quickly while retaining most of its juices without drying out.

10. The lid of claim 8 wherein the skewers hung onto the hooks attached to the lid make it easy to check the cooking progress of the food items by simply lifting the lid using the handle on top of the lid.

11. The lid of claim 8 wherein said angled sides bend towards said body which prevents said lid from falling off said body and make it easy to place said lid on said body with correct alignment.

12. The lid of claim 8 wherein said hooks allow skewers to be hung in a vertical direction which prevents the need to flip said skewers to cook both sides of said food items, allows the flavoring and/or sauces to solidify on said food items, leaves no char marks on said food items, and prevents food from being affected by flare-ups.

13. The lid of claim 8 wherein said hooks attached to the lid make it easy to interchange skewers and make it easy to add or remove said food items inside said body of the apparatus of claim 1.

14. The lid of claim 8 wherein said hooks are spaced appropriately making it easy to hang said skewers without said skewers touching each other.

15. The lid of claim 8 wherein said top handle is covered by a silicone sleeve which allows said lid to be picked up even when hot.

16. The apparatus of claim 1 wherein said apparatus and said grill/heat source is easy to clean as said food items do not come in contact with said body of the said apparatus or cooking surface of the said grill/heat source.

17. The apparatus of claim 1 wherein said apparatus enables cooking of larger quantities of food items with higher fuel efficiency due to the vertical cooking and heat trapping capabilities of the said apparatus than what is possible conventionally with just the heat source where food is placed horizontally on a cooking surface.

18. The apparatus of claim 1 wherein said apparatus can cook large pieces of food items, such as whole chickens, more reliably and evenly due to an even heating profile inside said apparatus than what is possible conventionally with just the heat source where food is placed horizontally on a cooking surface.
